(19) United States
(12) Patent Application Publication
(10) Pub. No.: US 2016/0125066 A1
(43) Pub. Date: May 5, 2016

(54) SYSTEMATIC AND ANALYTIC DATA SEGMENTATION

(71) Applicant: Beacon Intellectual Property Services, LLC, Alexandria, VA (US)

(72) Inventors: Rahul Kumar, Delhi (IN); Niket Agrawal, Noida (IN)

(21) Appl. No.: 14/930,599

(22) Filed: Nov. 2, 2015

(30) Foreign Application Priority Data
Oct. 31, 2014 (IN) 3134/DEL/2014

(51) Int. Cl. G06F 17/30

(52) U.S. Cl. CPC G06F 17/30598; G06F 17/30424; G06F 17/3053; G06Q 50/184

(57) ABSTRACT

A system and method for analyzing a competitor's patent activity data is presented. The system may comprise one or more processors, a search module, a categorization module, a grouping module, and an analysis module, where each of the components of the system are communicating with one another in a networked system environment. The one or more processors may be in communication with a plurality of databases, where the plurality of databases include a patent database, a client database, and a competitor database. The competitor's activity data is compared to that of the client's to segment the competitor's activity and set priority to certain categories of the segmented competitor's activity data. The presented system monitors the competitor's patenting activity.

### CROSS-REFERENCE TO RELATED APPLICATIONS

This application is a non-provisional application which claims the benefit to Indian Patent Application Number 3134/DEL/2014 filed on Oct. 31, 2014.

### BACKGROUND

1.

### Field of the Invention

The subject matter described herein relates generally to information distribution technology. More particularly, the present invention relates to analytic data segmentation and recommendation based thereon.

2. Description of Related Art

A current system and method for analyzing data utilizes fixed categories to generate a report. For instance, traditional patent watch services track and monitor patents and patent publications to generate analytic reporting of competitor's activity. Such tracking and monitoring is based on the legal status and timeline of the patents and patent publications, therefore such system and method is limited by a fixed categorization. Often times, data analysis of fixed categories provide the users with unnecessary information which increases the time it takes to further identify the meaningful data from the data analysis.

Therefore, what is needed is a system and method that effectively produces analysis of a competitor's activity customized to meet the client's standard.

### SUMMARY

The subject matter of this application may involve, in some cases, interrelated products, alternative solutions to a particular problem, and/or a plurality of different uses of a single system or article.

In one aspect, a system for analyzing a competitor's patent activity data is provided. The system may comprise one or more processors, a search module, a categorization module, a grouping module, and an analysis module, where each of the components of the system are communicating with one another in a networked system environment. The one or more processors may be in communication with a plurality of databases, where the plurality of databases include a patent database, a client database, and a competitor database.

The search module may be configured to identify a competitor's patent activity data from the patent database, where the competitor's patent activity data indicates patenting activities associated to the competitor. Further, the search module may identify client offerings from the client database. The client offerings may indicate business activities associated to a client. Further yet, the search module may identify competitor offerings from the competitor database, where the competitor offerings indicate business activities associated to the competitor.

The categorization module may be configured to segment each of the competitor's patent activity data, the client offerings, and the competitor offerings, into a plurality of categories. The grouping module may group the competitor's patent activity data, the client offerings, and the competitor offerings into a plurality of groups based on each of the plurality of categories, by correlating each of the plurality of categories to at least one of the client or the competitor. Finally, the analysis module may analyze the competitor's patent activity data, to generate recommendations to the client, based on the plurality of groups.

### BRIEF DESCRIPTION OF THE DRAWINGS

FIG. 1 provides an exemplary diagram of the system for analyzing competitor's activity data.

FIG. 2 provides an exemplary embodiment of the system for analyzing a competitor's activity data.

FIG. 3 provides an exemplary schematic of a recommendation logic based on four-group model.

FIG. 4 provides an exemplary illustration showing categorization of data performed by the categorization module.

FIG. 5 provides an exemplary embodiment of the grouping of the competitor's activity.

### DETAILED DESCRIPTION

The detailed description set forth below in connection with the appended drawings is intended as a description of presently preferred embodiments of the invention and does not represent the only forms in which the present invention may be constructed and/or utilized. The description sets forth the functions and the sequence of steps for constructing and operating the invention in connection with the illustrated embodiments.

In the present disclosure, a system and method for analyzing competitor's activity data is provided. The system may comprise one or more processors, one or more databases, a network, and one or more programs. The one or more programs may comprise instruction that, when executed, presents a user a user-specific data analysis of the competitor's activity data by employing the methods described herein. Additionally, the above mentioned system may further comprise a network where multiple users may have access thereto using a computing device. The system may be connected to the Internet.

In referring to the description, specific details are set forth in order to provide a thorough understanding of the examples disclosed. In other instances, well-known methods, procedures, components, and materials have not been described in detail as not to unnecessarily lengthen the present disclosure.

It should be understood that if an element or part is referred herein as being “on”, “against”, “in communication with”, “connected to”, “attached to”, or “coupled to” another element or part, then it can be directly on, against, in communication with, connected, attached or coupled to the other element or part, or intervening elements or parts may be present. When used, the term “and/or”, includes any and all combinations of one or more of the associated listed items, if so provided.

The terminology used herein is for the purpose of describing particular embodiments only and is not intended to be limiting. As used herein, the singular forms “a”, “an”, and “the”, are intended to include the plural forms as well, unless the context clearly indicates otherwise. It should be further understood that the terms “includes” and/or “including”, when used in the present specification, specify the presence of stated features, integers, steps, operations, elements, and/or components, but do not preclude the presence or addition of one or more other features, integers, steps, operations, elements, components, and/or groups thereof not explicitly stated.

Various operations may be described as multiple discrete operations in turn, in a manner that may be helpful in understanding embodiments; however, the order of description should not be construed to imply that these operations are order dependent.

Spatially relative terms, such as “under” “beneath”, “below”, “lower”, “above”, “upper”, “proximal”, “distal”, and the like, may be used herein for ease of description and/or illustration to describe one element or feature's relationship to another element(s) or feature(s) as illustrated in the various figures. It should be understood, however, that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, a relative spatial term such as “below” can encompass both an orientation of above and below. The device may be otherwise oriented (rotated 90 degrees or at other orientations) and the spatially relative descriptors used herein are to be interpreted accordingly. Similarly, the relative spatial terms “proximal” and “distal” may also be interchangeable, where applicable. Such descriptions are merely used to facilitate the discussion and are not intended to restrict the application of disclosed embodiments.

The terms first, second, third, etc. may be used herein to describe various elements, components, regions, parts and/or sections. It should be understood that these elements, components, regions, parts and/or sections should not be limited by these terms. These terms have been used only to distinguish one element, component, region, part, or section from another region, part, or section. Thus, a first element, component, region, part, or section discussed below could be termed a second element, component, region, part, or section without departing from the teachings herein.

Some embodiments of the present invention may be practiced on a computer system that includes, in general, one or a plurality of processors for processing information and instructions, RAM, for storing information and instructions, ROM, for storing static information and instructions, a database such as a magnetic or optical disk and disk drive for storing information and instructions, modules as software units executing on a processor, an optional user output device such as a display screen device (e.g., a monitor) for display screening information to the computer user, and an optional user input device.

As will be appreciated by those skilled in the art, the present examples may be embodied, at least in part, a computer program product embodied in any tangible medium of expression having computer-usable program code stored therein. For example, some embodiments described below with reference to flowchart illustrations and/or block diagrams of methods, apparatus (systems) and computer program products can be implemented by computer program instructions. The computer program instructions may be stored in computer-readable media that can direct a computer or other programmable data processing apparatus to function in a particular manner, such that the instructions stored in the computer-readable media constitute an article of manufacture including instructions and processes which implement the function/act/step specified in the flowchart and/or block diagram. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

In the following description, reference is made to the accompanying drawings which are illustrations of embodiments in which the disclosed invention may be practiced. It is to be understood, however, that those skilled in the art may develop other structural and functional modifications without departing from the novelty and scope of the instant disclosure.

Generally, the present disclosure provides a method and system for analyzing competitor's activity data. A user, herein also referred to as a client, may have a need to analyze the market data or any activity data of a competing entity (competitor) in order to achieve various objectives, such as to decide a direction of R&D, to evaluate due diligence on an investment decision, and the like. Accordingly, the competitor's activity data may include data from various sources, which may include, a patent database, a publication database, various information sources, marketing data, stock data, and the like. In its essence, the activity data refers to various types of information that entails activities of a company, such as a competing entity.

The system for analyzing a competitor's patent activity data may comprise one or more computers or computerized elements, in communication with one another, working together to carry out the different functions of the system. The invention contemplated herein may further comprise a non-transitory computer readable media configured to instruct a computer or computers to carry out the steps and functions of the system and method, as described herein. In some embodiments, the communication among the one or more computer or the one or more processors alike, may support a plurality of encryption/decryption methods and mechanisms of various types of data.

The system may comprise a computerized user interface provided in one or more computing devices in networked communication with each other. The computer or computers of the computerized user interface contemplated herein may comprise a memory, processor, and input/output system. In some embodiments, the computer may further comprise a networked connection and/or a display screen. These computerized elements may work together within a network to provide functionality to the computerized user interface. The computerized user interface may be any type of computerized interfaces known in the art capable of allowing a user to input data and receive a feedback therefrom. The computerized user interface may further provide outputs executed by the system contemplated herein.

Database and data contemplated herein may be in the format including, but are not limiting to, XML, JSON, CSV, binary, over any connection type: serial, Ethernet, etc. over any protocol: UDP, TCP, and the like.

Computer or computing device contemplated herein may include, but are not limited to, virtual systems, Cloud/remote systems, desktop computers, laptop computers, tablet computers, handheld computers, smartphones and other cellular phones, and similar internet enabled mobile devices, digital cameras, a customized computing device configured to specifically carry out the methods contemplated in this disclosure, and the like.

Network contemplated herein may include, for example, one or more of the Internet, Wide Area Networks (WANs), Local Area Networks (LANs), analog or digital wired and wireless telephone networks (e.g., a PSTN, Integrated Services Digital Network (ISDN), a cellular network, and Digital Subscriber

Line (xDSL)), radio, television, cable, satellite, and/or any other delivery or tunneling mechanism for carrying data. Network may include multiple networks or sub-networks, each of which may include, for example, a wired or wireless data pathway. The network may include a circuit-switched voice network, a packet-switched data network, or any other network able to carry electronic communications. Examples include, but are not limited to, Picture Transfer Protocol (PTP) over Internet Protocol (IP), IP over Bluetooth, IP over WiFi, and PTP over IP networks (PTP/IP).

The present disclosure provides a system and method that compares competitor's activity data to that of the client's to segment the competitor's activity and set priority to certain categories of the segmented competitor's activity data. Specifically, the present disclosure provides a system and method that monitors the competitor's patenting activity. The competitor's patenting activity may be cross-checked against the competitor's activity data (other than the patent activity) and the client's activity data. As such, analysis and monitoring of categories, such as technical field or industry type, regarding the competitor may be identified via the presently disclosed system and method.

In one aspect, a method and apparatus for analyzing competitor's activity data may be specific, but not to be limited, to analyzing the competitor's patent activity data.

Patent activity data may include, any activity relating to patent, such as issued patents, patent publications, and patent prosecution status. The competitor's patent activity data may belong to any available jurisdictions. Patent activity data are readily available to public within a patent database. While this database is accessible to the public, there is a need for a system and method that enables specific function to make use of the patent activity data for varying purposes, such as monitoring the competitor's business activities.

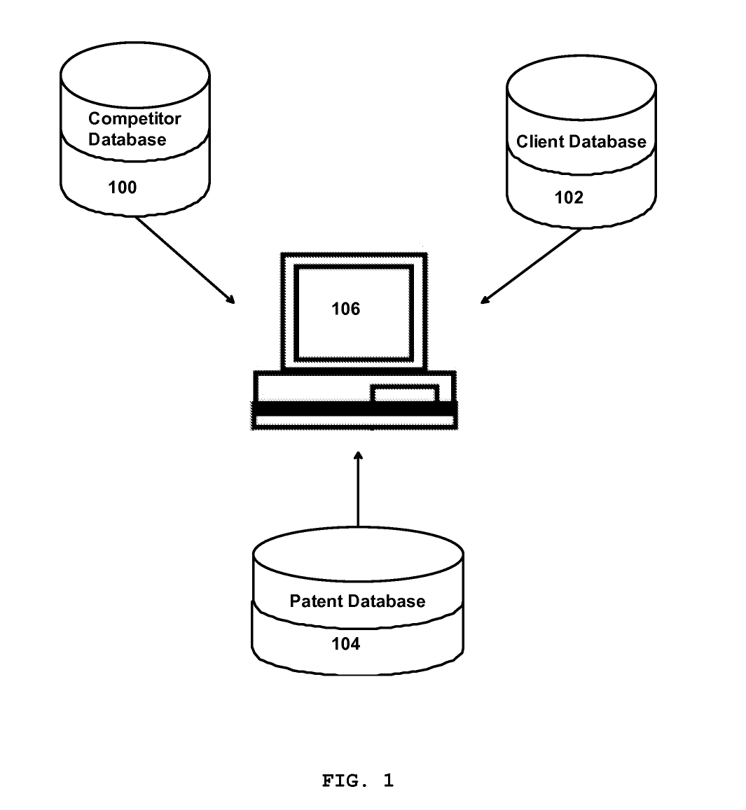

FIG. 1 provides an exemplary diagram of the system for analyzing competitor's activity data. As shown in FIG. 1, the system for analyzing competitor's activity data may gather data from multiple databases. The multiple databases 100 102 104 may include a patent database 104, a client database 102, and a competitor database 100. The multiple databases may be linked to a network, such as the Internet, enabling communication among one another.

In one embodiment, the client, using a computing device 106, may gather information from a competitor database 100 which comprises data specific to the competitor. By way of example, the competitor database 100 may comprise a product or service offerings by the competitor. In another embodiment, the client may gather information from a client database 102 which comprises data specific to the client. By way of example, the client database 102 may comprise a product or service offerings by the client. The product or service offerings are products and/or services being marketed to the public by either the competitor or the client.

In yet another embodiment, the client may utilize the computing device 106 to gather competitor's activity data from multiple differing sources/databases to compare with the client's own activity data. By way of an example, the computing device 106 may gather competitor-related-data from a competitor's patent activity data and a competitor's non-patent activity data. The two different sources of databases may be then compared with the client's own activity data and/or the client's own patent activity data to analyze the competitor's activity data from different sources. The patent activity data of a client and a competitor may be identified from the patent database 104. By comparing the data specific to the client with the data specific to the competitor, the client may access categories of activities that are shared between the two entities (the client and the competitor), mutually exclusive between the two entities, and not existing between the two entities.

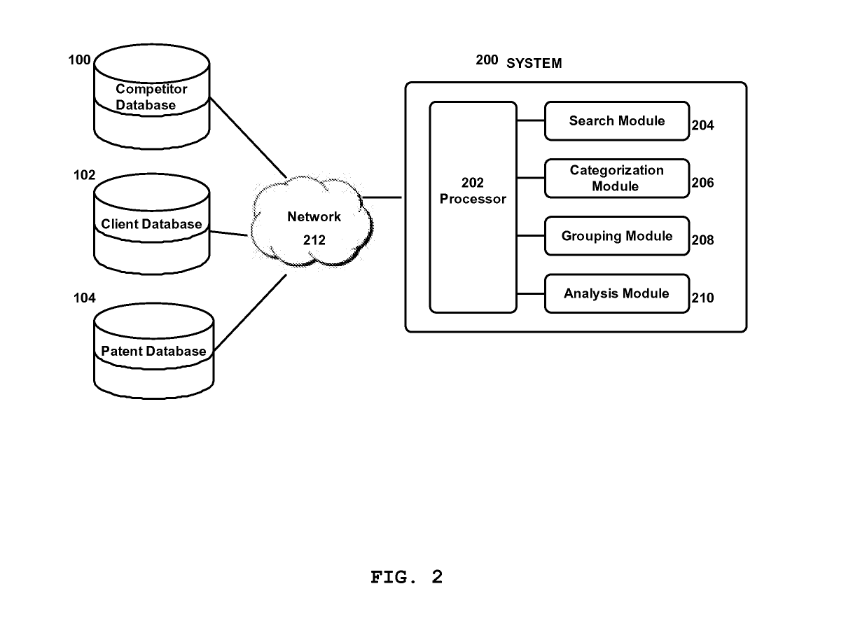

In FIG. 2, an exemplary embodiment of the system 200 for analyzing a competitor's activity data is presented. In one embodiment, the system may comprise a one or more processors 202 in communication with a search module 204, a categorization module 206, a grouping module 208, and an analysis module 210. The one or more processors may be in communication with the multiple databases 100 102 104 via a network 212.

The search module 204 may gather data from the one or more databases. In some embodiments, the search module 204 may comprise a web crawler to gather activity data associated to the competitor and/or the client. Those having ordinary skill in the art would readily understand the variety of methods available to gather required data from a database.

In some embodiments, the categorization module 206 may categorize the data gathered by the search module 204 in to multiple categories to segment the gathered data. By way of example, the data may be segmented in to categories with regards to the technical field, pricing, release data, popularity and more. The categorization module 206 may categorize and tag the gathered data with a category of interest. The gathered data may be segmented or tagged with one or more types of categories. Similarly, the scope of the categories may be exclusive and/or inclusive to one another, in order to provide a multi-layered scope of categories.

In some embodiments, the grouping module 208 may further analyze the data generated by the categorization module 206. The categorized data may be grouped in to multiple groups by comparing the categorized data and correlating them based on the categories. In the embodiment presented in FIG. 2, the categorization module 206 may categorize the data gathered from three different sources: a competitor database 100, a client database 102, and a competitor's patent database 104. Each of the data gathered from the three databases 100 102 104 may be grouped by comparing the categories of the data, such as a technology type. The categories may belong commonly to all three of the databases. In another aspect, the categories of the data may be common to two of the three databases. Accordingly, the categories of the data may be unique to one of the three sources, therefore not being common to other two databases. The grouping module 208 may group the data with the same or similar categories for further analysis of the competitor's activity data, such as the patent activity data.

In some embodiments, the analysis module 210 may further link the grouped data to recommend the client with certain recommendations. The recommendation may be specific to the group and/or the category. By way of example, the client may be recommended by the system to change the direction of the R&D, when certain category of the client data is shared with the competitor, because such sharing may indicate competitive market. Such recommendations based on the grouping and categorization presented by the system would be obvious to person having ordinary skills in the art.

A method for analyzing competitor's activity data is provided. The method may utilize the system described above. In general, the method gathers data specific to the competitor and compares it against data specific to the client or the user.

In some embodiments, data may be collected from multiple database sources, such as client database, competitor database, and competitor's activity data. Once the data from multiple databases are collected by the search module, the client specific data may be segmented into multiple categories by the categorization module. Similarly, the competitor specific data may be segmented into multiple categories. Further, the competitor's activity data may further be segmented into multiple categories. Once collected data are segmented to categories, grouping may be conducted by the grouping module to generate and analyze the competitor's activity data. The competitor's activity data may comprise multiple groups based on the categories from the client specific data, the competitor specific data, and the competitor's activity data. In order to group the competitor's activity data, the categories segmented into each of the data sets may be linked and compared to identify correlation among each of the entries within the collected data. The grouped competitor's activity data may further be analyzed to generate recommendation to the client in view of the client's activity data, such as the client offering data.

In one embodiment, data may be gathered from two data sources, where one is specific to the client and another is specific to the competitor. The two data may be segmented into multiple categories and grouped similarly.

In another embodiment, the client and competitor data may be segmented into mutually exclusive comprehensive categories. The client and competitor data may be categorized based on product & services offerings, technology offering, research areas, and/or patent portfolio, and the like.

In yet another embodiment, the categories may be customized by the client or the user. Similarly, segmentation of the data may be customized by the client or the user.

The competitor's activity data may be identified from any activity of the competitor. In one embodiment, the competitor's activity data can be associated to a particular time frame, or it can be monitored on real-time basis.

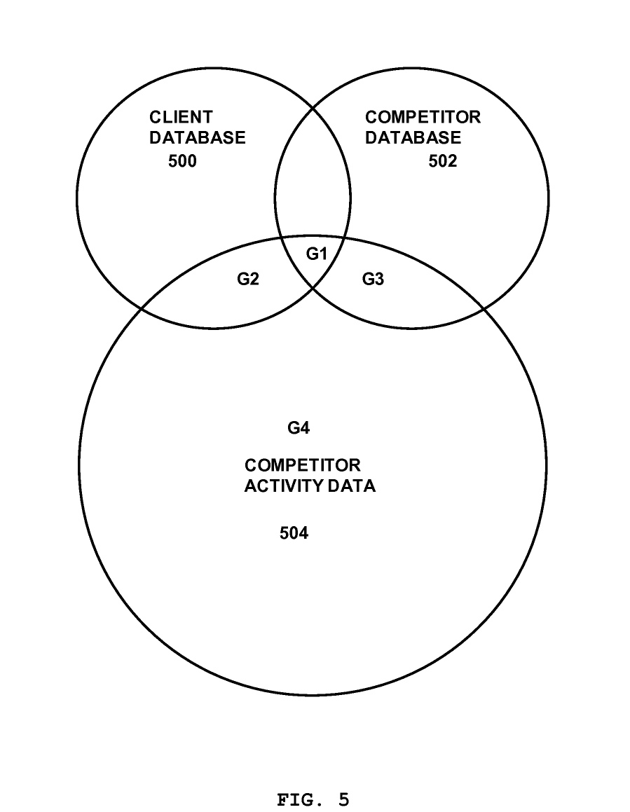

FIG. 5 illustrates an exemplary embodiment of the grouping of the competitor's activity which comprises four groups from three different data sources 500 502 504. The competitor's activity data 504 may be a patent activity data. The group, G2, may contain the competitor's activity data 504 having plurality of categories, where the plurality of categories are commonly and uniquely belongs to at least one of the plurality of categories specific to the client database 500.

The group, G3, may contain the competitor's activity data 504 having plurality of categories, where the plurality of categories are commonly and uniquely belongs to at least one of the plurality of categories specific to the competitor database 502.

The group, G1, may contain the competitor's activity data 504 having plurality of categories, where the plurality of categories are commonly and uniquely belongs both to the plurality of categories specific to the competitor 502 and the client databases 500.

Lastly, the group, G4 may contain the competitor's activity data 504 having plurality of categories, where the pluralities of categories are not specific either to the competitor database 502 or the client database 500.

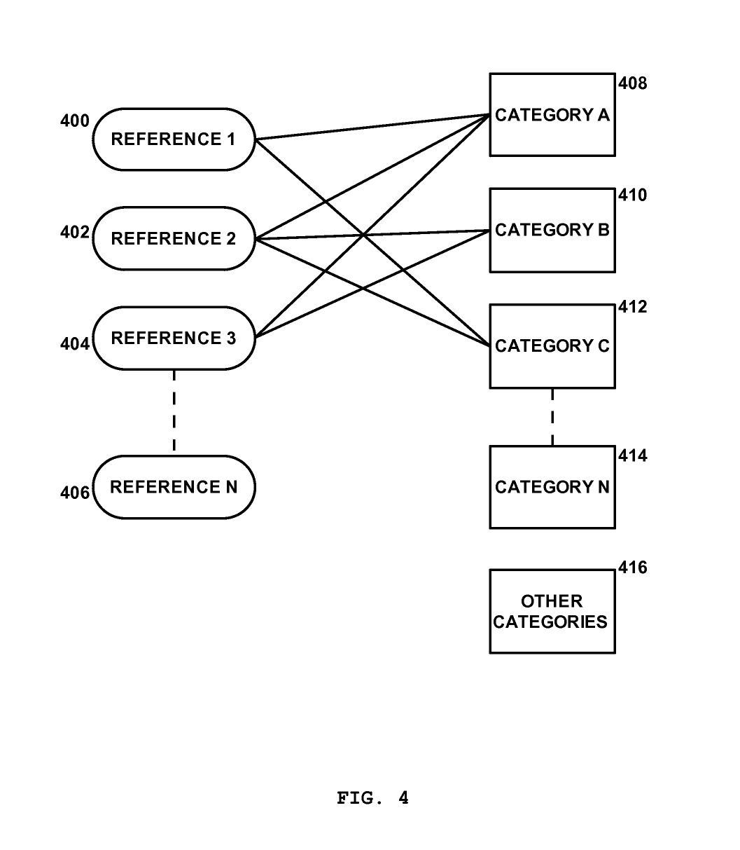

FIG. 4 illustrates an exemplary embodiment showing categorization of data performed by the categorization module 206. The references (reference 1, 2, 3, 4, N) 400 402 404 406 represent entries within the data. Each of the entries may be associated with categories (category A, B, C, N) 408 410 412 414 and the other categories 416. Such categorization of data may be utilized for grouping the data. Each reference may be associated with none to one or more categories.

Examples of conducting the method and system provided herein from the data generated from two sources are provided. In this example, client may want to associate the competitor's activity data in two separate groups. The activity data would be associated to group 1 if it overlaps with any of the client categories. And if it does not overlap with any of the client categories, it would get associated to group 2.

By way of example, the client may be a research institute/university, and the client may utilize the disclose system and method to analyze research being done by another university in the previous two years. In this example, the client is considering another university as the competitor. As such, the competitor's activity data may be research and journal publications that may be compared to that of the client. Other examples may include: Corporate wanting insights on recent patent grant trends for a competitor; A product manufacturing company may want to review the releases of new versions of products of their competitor.

The grouped data may be further analyzed. In one embodiment, weights can be assigned to each of the multiple categories specific to client and competitor based on a set of rules. Such rules may relate to relevancy and importance of the multiple categories customizable to the client. A relevancy score may be calculated for each of the multiple groups based on weight of the categories within a group and/or frequency of the categories in comparison to the competitor's activity data.

In another embodiment, weights can also be assigned to various groups based on a set of rules adapted to relevance and importance of these groups to the client. An overall activity score is calculated based on relevance score of each group. A person having ordinary skill in the art would understand the various methods for ranking or arranging the data in order of relevancy or weights.

Recommendation may be generated by the analysis module, which may be based on one or more or any combinations of the segmentation of activity data in groups, relevance score of groups, and overall activity score. The reports with scores and recommendation can be done using UI, dashboard and/or any other type of document (word, excel etc).

The system can be configured to analyze activity data of multiple competitors simultaneously. Client and competitor specific data categories or grouping once generated can be reused.

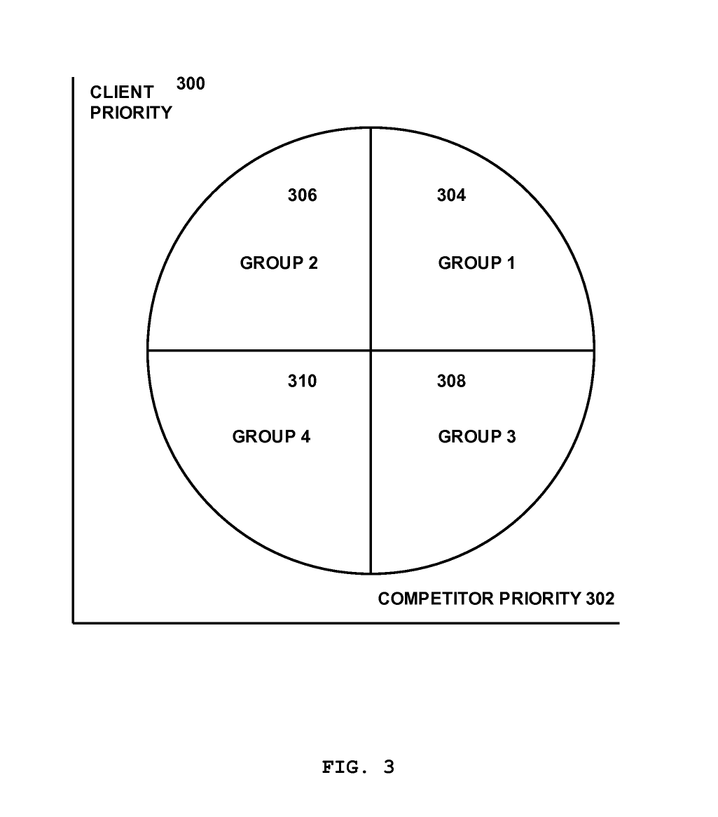

FIG. 3 shows an exemplary schematic of a recommendation logic based on four group model disclosed in FIG. 5. In this embodiment, the competitor's activity data 504 is to be competitor's patent activity data. The client database 500 comprises a product or service offerings by the client. And the competitor database 502 comprises a product or service offerings by the competitor. Group 2 (G2) 306 is shared between the client database 500 and the competitor's patent activity data 504. As such, the client may be recommended to be involved in more patent activity themselves. Group 3 (G3) 308 is shared between the competitor database 502 and the competitor's patent activity data 504. As such, Group 3 308 represents strong correlation between the competitor's product or services and the competitor's patent activity data 504, therefore the client may be recommended to approach related categories of Group 3 308 with caution. Group 1 304 is shared among the client database 500, the competitor database 502, and the competitor's activity data 504. As such, the recommendation to the client may be to inform that categories within Group 3 308 are competitive. Finally, Group 4 (G4) 310 has no relation to the client 500 and the competitor data 502, but exists in the competitor's activity data 504. As such the client may be recommended or informed that the competitor may be diversifying their product or services.

This example of recommendation logic may be varied depending on the circumstances. A person having ordinary skill in the art would understand such variations.

In conclusion, a system for analyzing a competitor's patent activity data is provided. The system may comprise one or more processors, a search module, a categorization module, a grouping module, and an analysis module, where each of the components of the system are communicating with one another in a networked system environment. The one or more processors may be in communication with a plurality of databases, where the plurality of databases include a patent database, a client database, and a competitor database.

The search module may be configured to identify a competitor's patent activity data from the patent database, where the competitor's patent activity data indicates patenting activities associated to the competitor. Further, the search module may identify client offerings from the client database. The client offerings may indicate business activities associated to a client. Further yet, the search module may identify competitor offerings from the competitor database, where the competitor offerings indicate business activities associated to the competitor.

The categorization module may be configured to segment each of the competitor's patent activity data, the client offerings, and the competitor offerings, into a plurality of categories. The grouping module may group the competitor's patent activity data, the client offerings, and the competitor offerings into a plurality of groups based on each of the plurality of categories, by correlating each of the plurality of categories to at least one of the client or the competitor. Finally, the analysis module may analyze the competitor's patent activity data, to generate recommendations to the client, based on the plurality of groups.

While several variations of the present invention have been illustrated by way of example in preferred or particular embodiments, it is apparent that further embodiments could be developed within the spirit and scope of the present invention, or the inventive concept thereof. However, it is to be expressly understood that such modifications and adaptations are within the spirit and scope of the present invention, and are inclusive, but not limited to the following appended claims as set forth.

Those skilled in the art will readily observe that numerous modifications, applications and alterations of the device and method may be made while retaining the teachings of the present invention.

What is claimed is:

1. A system for analyzing a competitor's patent activity data, the system comprising:
one or more processors in communication with each other via a network, the one or more processors in communication with a plurality of databases, the plurality of databases including a patent database, a client database, and a competitor database;
a search module, in communication with the one or more processors, configured to:
identify a competitor's patent activity data from the patent database, the competitor's patent activity data indicating patenting activities associated to the competitor;
identify client offerings from the client database, the client offerings indicating business activities associated to a client; and
identify competitor offerings from the competitor database, the competitor offerings indicting business activities associated to the competitor;
a categorization module, in communication with the one or more processors, being configured to segment each of the competitor's patent activity data, the client offerings, and the competitor offerings, into a plurality of categories;
a grouping module, in communication with the one or more processors, grouping the competitor's patent activity data, the client offerings, and the competitor offerings into a plurality of groups based on each of the plurality of categories, by correlating each of the plurality of categories to at least one of the client or the competitor; and
an analysis module, in communication with the one or more processors, analyzing the competitor's patent activity data, to generate recommendations to the client, based on the plurality of groups.

2. The system of claim 1 wherein the plurality of groups comprises:
a first group, wherein the first group contains the competitor's patent activity data having one or more of the plurality of categories, which is commonly associated to the client;
a second group, wherein the second group contains the competitor's patent activity data having one or more of the plurality categories, which is commonly associated to the competitor;
a third group, wherein the third group contains the competitor's patent activity data having one or more of the plurality of categories, which is commonly associated to both the client and the competitor; and
a fourth group, wherein the fourth group contains the competitor's patent activity data having one or more of the plurality of categories, which is associated to neither of the client nor the competitor.

3. The system of claim 1, wherein the analysis module analyzes the competitor's patent activity data by assigning a higher rank to the competitor's patent activity data based on the number of the plurality of categories segmented to the competitor's patent activity data.

4. The system of claim 1, wherein the analysis module analyzes the competitor's patent activity data by assigning a higher rank to competitor's patent activity data based on the relevancy of the plurality of categories segmented to the competitor's patent activity data.

5. The system of claim 1, wherein the plurality of categories are selected from the group consisting of technology categories, geographical locations, jurisdictional locations, and market index.

6. The system of claim 1, wherein the one or more processors is operating on a server in communication with the plurality of databases via the network.

7. The system of claim 1, wherein the one or more processors is operated by a computing device having the plurality of databases integrated therein.

8. A method for analyzing competitor's patent activity data, using a one or more processors in communication with each other via a network, the one or more processors in communication with a plurality of databases, wherein the plurality of databases includes a patent database, a client database, and a competitor database, the method comprising the steps of:
identifying a competitor's patent activity data from the patent database, with a search module in communication with the one or more processors, the competitor's patent activity data indicating patenting activities associated to the competitor;
identifying client offerings from the client database, with the search module, the client offerings indicating business activities associated to a client;
identifying competitor offerings from the competitor database, with the search module, the competitor offerings indicting business activities associated to the competitor;
segmenting, with a categorization module in communication with the one or more processors, each of the competitor's patent activity data, the client offering, and the competitor offerings, into a plurality of categories;
grouping, with a grouping module in communication with the one or more processors, the competitor's patent activity data, the client offerings, and the competitor offerings into a plurality of groups based on each of the plurality of categories, by correlating each of the plurality of categories to at least one of the client or the competitor; and
analyzing, with an analysis module in communication with the one or more processors, the competitor's patent activity data, to generate recommendations to the client, based on the plurality of groups.

9. The method of claim 8, wherein the step of grouping the competitor's patent activity data, the client offerings, and the competitor offerings into a plurality of groups, comprises defining the plurality of groups as:
a first group, wherein the first group contains the competitor's patent activity data having one or more of the plurality of categories, which is commonly associated to the client;
a second group, wherein the second group contains the competitor's patent activity data having one or more of the plurality categories, which is commonly associated to the competitor;
a third group, wherein the third group contains the competitor's patent activity data having one or more of the plurality of categories, which is commonly associated to both the client and the competitor; and
a fourth group, wherein the fourth group contains the competitor's patent activity data having one or more of the plurality of categories, which is associated to neither of the client nor the competitor.

10. The method of claim 8, wherein the step of analyzing the competitor's patent activity data further comprises assigning a higher rank to the competitor's patent activity data based on the number of the plurality of categories segmented to the competitor's patent activity data.

11. The method of claim 8, wherein the step of analyzing the competitor's patent activity data further comprises assigning a higher rank to competitor's patent activity data based on the relevancy of the plurality of categories segmented to the competitor's patent activity data.

12. The method of claim 8, wherein the plurality of categories are selected from the group consisting of technology categories, geographical locations, jurisdictional locations, and market index.

13. The method of claim 8, wherein the one or more processors is operating on a server in communication with the plurality of databases via the network.

14. The method of claim 8, wherein the one or more processors is operated by a computing device having the plurality of databases integrated therein.

15. A non-transitory computer readable medium storing executable instructions which, when executed, cause one or more processors to perform the following steps for analyzing competitor's patent activity data, the one or more processors in communication with each other via a network, the one or more processors in communication with a plurality of databases, wherein the plurality of databases includes a patent database, a client database, and a competitor database, the steps comprising:
identifying a competitor's patent activity data from the patent database, with a search module in communication with the one or more processors, the competitor's patent activity data indicating patenting activities associated to the competitor;
identifying client offerings from the client database, with the search module, the client offerings indicating business activities associated to a client;
identifying competitor offerings from the competitor database, with the search module, the competitor offerings indicting business activities associated to the competitor;
segmenting, with a categorization module in communication with the one or more processors, each of the competitor's patent activity data, the client offering, and the competitor offerings, into a plurality of categories;
grouping, with a grouping module in communication with the one or more processors, the competitor's patent activity data, the client offerings, and the competitor offerings into a plurality of groups based on each of the plurality of categories, by correlating each of the plurality of categories to at least one of the client or the competitor; and
analyzing, with an analysis module in communication with the one or more processors, the competitor's patent activity data, to generate recommendations to the client, based on the plurality of groups.

16. The method of claim 15, wherein the step of grouping the competitor's patent activity data, the client offerings, and the competitor offerings into a plurality of groups, comprises defining the plurality of groups as:
a first group, wherein the first group contains the competitor's patent activity data having one or more of the plurality of categories, which is commonly associated to the client;
a second group, wherein the second group contains the competitor's patent activity data having one or more of the plurality categories, which is commonly associated to the competitor;
a third group, wherein the third group contains the competitor's patent activity data having one or more of the plurality of categories, which is commonly associated to both the client and the competitor; and
a fourth group, wherein the fourth group contains the competitor's patent activity data having one or more of the plurality of categories, which is associated to neither of the client nor the competitor.

17. The method of claim 15, wherein the step of analyzing the competitor's patent activity data further comprises assigning a higher rank to the competitor's patent activity data based on the number of the plurality of categories segmented to the competitor's patent activity data.

18. The method of claim 15, wherein the step of analyzing the competitor's patent activity data further comprises assigning a higher rank to competitor's patent activity data based on the relevancy of the plurality of categories segmented to the competitor's patent activity data.

19. The method of claim 15, wherein the plurality of categories are selected from the group consisting of technology categories, geographical locations, jurisdictional locations, and market index.

20. The method of claim 15, wherein the one or more processors is operating on a server in communication with the plurality of databases via the network.
